(19) United States
(12) Patent Application Publication
(10) Pub. No.: US 2014/0249837 A1
(43) Pub. Date: Sep. 4, 2014

(54) Methods And Systems For Facilitating Use Of Healthcare And Social Service Resources In A Community

(71) Applicant: The Charlotte-Mecklenburg Hospital Authority d/b/a Carolinas Healthcare System, Charlotte, NC (US)

(72) Inventors: Michael Dulin, Charlotte, NC (US); Ed Connors, East Stroudsburg, PA (US)

(73) Assignee: The Charlotte-Mecklenburg Hospital Authority d/b/a Carolinas Healthcare System, Charlotte, NC (US)

(21) Appl. No.: 14/193,445

(22) Filed: Feb. 28, 2014

Related U.S. Application Data
(60) Provisional application No. 61/770,436, filed on Feb. 28, 2013.

(51) Int. Cl. G06Q 50/22; G06Q 30/06; G06F 17/30

(52) U.S. Cl. CPC G06Q 50/22; G06F 17/30702; G06Q 30/0631
USPC 705/2

(57) ABSTRACT

Methods and systems are provided to facilitate the identification and connection of unique, relevant, and personalized healthcare and social service resources in a distributed user community in an automated manner to support and improve the health of communities. A method is provided that at least includes aggregating data about a plurality of community healthcare and social service resources, wherein resource profiles are generated for each of the plurality of community resources; generating user profiles for one or more community users, wherein the user profiles comprise indications of needs and preferences for the one or more community users in regard to healthcare and social services; receiving a query from one of the community users regarding a need for healthcare or social services; and generating a list of recommendations from the community resources based on the query and the user profile of the one of the community users. A corresponding system is also provided.

### CROSS-REFERENCE TO RELATED APPLICATIONS

The present application claims the benefit of U.S. Provisional Application No. 61/770,436, entitled “Methods And Systems For Facilitating Use Of Healthcare And Social Service Resources In A Community”, filed on Feb. 28, 2013, the contents of which is incorporated by reference herein in its entirety.

### TECHNOLOGICAL FIELD

Example embodiments of the present invention relates generally to providing information, recommendations, and connections to healthcare and social services resources.

### BACKGROUND

In many communities, individuals go without health and social services care because they do not know how to find or access the appropriate services and often do not know where to go. Further, if recommendations are made for care, they may not make sense to the individual, and if they do, additional hurdles may prevent the individual from seeking the appropriate care.

Supporting and improving the health of communities requires community intervention and the support of various community resources, such as demonstrated by the Wagner Chronic Care Model. Such efforts are often implemented by providing identification and connection to resources through direct interaction, such as through social workers, or by phone.

Some methods for identifying such resources include paper-based directories and computer based systems using phone or web-based access. Paper and phone based community resource systems, while helpful, are limited by being neither current nor personalized and in most cases require trained personal to interpret needs and suggest resource solutions.

Paper-based directories, often used in direct interaction scenarios, may quickly become stagnant and rarely contain the necessary amount of information to allow for recommendations tailored to a specific situation or individual. Computer based systems may provide more assistance in identifying available resources, but are often general in nature and do not allow for highly customizable search results or provide tailored recommendations for the individual.

Additionally, health promoting strategies designed for majority populations have been found not to be equally effective when applied to minority populations. A large part of the differential impact occurs due to several factors, including non-uniform implementation due to lack of access to technology.

### BRIEF SUMMARY

Methods and systems are therefore provided according to example embodiments of the present invention to facilitate the identification and connection of unique, relevant, and personalized healthcare and social service resources in a distributed user community in an automated manner to support and improve the health of communities.

Example embodiments of the present invention provide methods and systems that comprise forming a community engagement network of health, social service, and educational professionals that may serve as intermediaries and surrogates to connect vulnerable individuals to health and community resources.

In one embodiment, a method is provided that at least includes aggregating data about a plurality of community healthcare and social service resources, wherein resource profiles are generated for each of the plurality of community resources; generating user profiles for one or more community users, wherein the user profiles comprise indications of needs and preferences for the one or more community users in regard to healthcare and social services; receiving a query from one of the community users regarding a need for healthcare or social services; and generating a list of recommendations from the community resources based on the query and the user profile of the one of the community users.

In some embodiments, the method may further comprise providing feedback regarding the community user interaction with the community resource. In some embodiments, generating the list of recommendations may be further based on an analysis of similarities between a plurality of community users. In some embodiments, generating the list of recommendations may be based in part on a referral from one or more healthcare providers or social service professionals.

In some embodiments, the method may further comprise providing access to content, including educational content from one or more sources, based on a need identified from the query and the community user profile. In some embodiments, the method may further comprise providing access to an interactive forum based on a need identified from the query and the community user profile.

In some embodiments, the method may further comprise providing analysis of community user and community resource interactions wherein the analysis may be used in developing health or wellness programs for a community.

In a further embodiment, a system is provided comprising a plurality of devices in communication, each of the devices comprising at least one processor and at least one memory including computer program instructions, the system configured to at least: aggregate data about a plurality of community healthcare and social service resources, wherein resource profiles are generated for each of the plurality of community resources; generate user profiles for one or more community users, wherein the user profiles comprise indications of needs and preferences for the one or more community users in regard to healthcare and social services; receive a query from one of the community users regarding a need for healthcare or social services; and generate a list of recommendations from the community resources based on the query and the user profile of the one of the community users.

In some embodiments, the system may be further configured to provide feedback regarding the community user interaction with the community resource. In some embodiments, generating the list of recommendations may be further based on an analysis of similarities between a plurality of community users. In some embodiments, generating the list of recommendations may be based in part on a referral from one or more healthcare providers or social service professionals.

In some embodiments, the system may be further configured to provide access to content, including educational content from one or more sources, based on a need identified from the query and the community user profile. In some embodiments, the system may be further configured to provide access to an interactive forum based on a need identified from the query and the community user profile.

In some embodiments, the system may be further configured to provide analysis of community user and community resource interactions wherein the analysis may be used in developing health or wellness programs for a community.

In a further embodiment, a computer program product is provided comprising at least one non-transitory computer-readable storage medium bearing computer program instructions embodied therein for use with a computer, the computer program instructions comprising program instructions configured to aggregate data about a plurality of community healthcare and social service resources, wherein resource profiles are generated for each of the plurality of community resources; generate user profiles for one or more community users, wherein the user profiles comprise indications of needs and preferences for the one or more community users in regard to healthcare and social services; receive a query from one of the community users regarding a need for healthcare or social services; and generate a list of recommendations from the community resources based on the query and the user profile of the one of the community users.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a diagram of a system to facilitate access to healthcare and social service resources in a community in accordance with an example embodiment of the present invention;

FIG. 2 is an illustration of a portal to provide access to healthcare and social service resource in accordance with an example embodiment of the present invention;

FIG. 3 is a flow chart illustrating operations performed by a system in accordance with an example embodiment of the present invention;

FIG. 4 is an illustration of aspects of the Portal from the perspective of a Community User in accordance with an example embodiment of the present invention;

FIG. 5 is an illustration of the collection and provisioning of data in accordance with an example embodiment of the present invention;

FIG. 6 is a flow chart illustrating processes provided by a system in accordance with an example embodiment of the present invention;

FIG. 7 is an illustration of the integration of a portal with a Health Information Exchange or Hospital IT System in accordance with an example embodiment of the present invention; and

FIG. 8 is a block diagram of an apparatus that may be specifically configured in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Methods and systems are provided in accordance with an example embodiment of the present invention to facilitate recommendations and access to healthcare and social service resources in a community.

Such methods and systems facilitate the identification and connection of unique, relevant, and personalized healthcare and social service resources in a distributed user community in an automated manner to support and improve the health of communities.

Embodiments of the current inventions provide a web based solution powered by recommender technology that provides all the features of paper-based directories and phone recommendation systems and also provides a fuller range of capabilities, concurrency, cost efficiency, user privacy, and simultaneously deliver more useful and interactive services for communities.

Recommender systems or recommendation systems are a subclass of information filtering systems that seek to predict the ‘rating’ or ‘preference’ that a user would give to an item (such as music, books, or movies) or social element (e.g. people or groups) they had not yet considered, using a model built from the characteristics of an item (content-based approaches) or the user's social environment (collaborative filtering approaches).

Example embodiments provide a novel internet based system (or Portal) for improving the health of a community that uniquely connects individuals in that community with tailored and personalized resource recommendations that includes health and social service resources but also secondary resources that can assist in a person achieving better health. Unlike paper based and phone systems, the Portal provides convenient, private, and a highly tailored recommender system for users looking for suitable services. The Portal helps eliminate user frustration and poor utilization often associated with paper based and phone based systems.

Efforts to engage health and social services resources with users have often been met with lackluster results. Paper based systems are stagnant and frequently contain frustratingly out-of-date information. Translating and conveying paper based data require extensive and ongoing trained labor for interacting with the community. But users frequently have specific and unique needs; such as insurance type, language needs, time availability, or availability of transport, and while extremely important to the user these variables are beyond the ability of many practitioners to cognitively filter instantaneously the many and complex needs with the particulars of resources. Phone based systems go a little further by facilitating more convenient phone conversation with a person having access to a resource database but there is a similar cognitive challenge for the phone operator. Both users and phone operators become frustrated as they attempt to integrate the caller's particular needs and preferences with a list of resources to make informed recommendations. Some systems have gone further by offering internet based resource recommendations but the user interface is often poor, recommendations are not personalized, and such systems have not been well accepted. In many communities, individuals go without health and social services care because they do not know where to go, or if recommendations are made they may not make sense, and if they do, other hurdles may prevent the individual from accessing the resources.

The combination of systems, software, and user interfaces in the example embodiments make the Portal simple to use for Community Users and affordable by the community. For a system to have impact, it must be user friendly for all users: Community Users, Community Resources, and Community Healthcare Professionals. The Portal leverages unique user interfaces to assure this simplicity across these diverse users. Also, for a system to be impactful, its upfront and ongoing cost must be sufficiently low and affordable. The Portal is highly scalable making resources available at the town, county, state, or even national level with minimal incremental expense.

One key result provided by embodiments of the current invention is in the reduction of unnecessary emergency room visits. While there are many community health improvements linked to the Portal, one clear positive financial impact is that increased primary care visits inversely impact hospital ER visits. As primary care visits are generally less costly than ER visits, local hospitals will see a reduction in unnecessary and often uncompensated ER visits with the additional benefit of a potential reduction for capital expansion for overcrowded ERs.

Embodiments of the current invention provide means to comprehensively implement a community care model and provide more accessible and actionable recommendations for local resources for healthcare and social services. Example embodiments are focused on more than just chronic conditions, as in some prior approaches, and also address assistance with acute events (e.g., dental or ophthalmic issues) and providing wellness and prevention resources.

Embodiments of the current invention provide an internet accessible gateway to essential community resources. Moreover, it is a means by which less computer savvy individuals can receive recommendations that most specifically fit their particular needs. It is also a means that can be accessed by individuals, healthcare providers, and community resources to form a vibrant exchange, social networks of ‘people like me’, and interactions that heretofore did not exist within a community.

Embodiments of the current invention permit community, county, state or national resource recommendations and provide an automated service that can immediately identify and connect those in need with appropriate, specific, and customized resources and also provide feedback to primary care physicians or other healthcare providers. Further, as embodiments are cloud based, they may be easily scalable, covering the national level but delivering local and personally relevant resource recommendations.

As discussed, embodiments of the current invention go beyond chronic care and also address Wellness and Prevention and other social service needs. As medical diagnostic technology has become increasingly sensitive, the means of identifying the onset of disease in asymptomatic patients has increased. This has created, in some cases, specific and effective means of prevention to halt or stall the progression of disease. For example, awareness of early and frequent dental exams reduces acute dental incidents, the effect of smoking cessation to reduce onset of heart disease, reduction in dietary salt intake to reduce high blood pressure associated with hypertension, or the taking of statin drugs to reduce cholesterol associated with coronary blockages and myocardial infarction. Further, as individuals become more aware of the means by which they can achieve a longer healthier life, certain wellness means are of interest. For example, users may choose: changing diet to offset the potential for being overweight or obese, incorporating exercise to minimize weight gain, or elect meditation to reduce stress. Users of the example embodiments, who may be unaware of the many free or low cost services by which they can access health or social services, can become aware and access these resources to achieve better wellness and prevention.

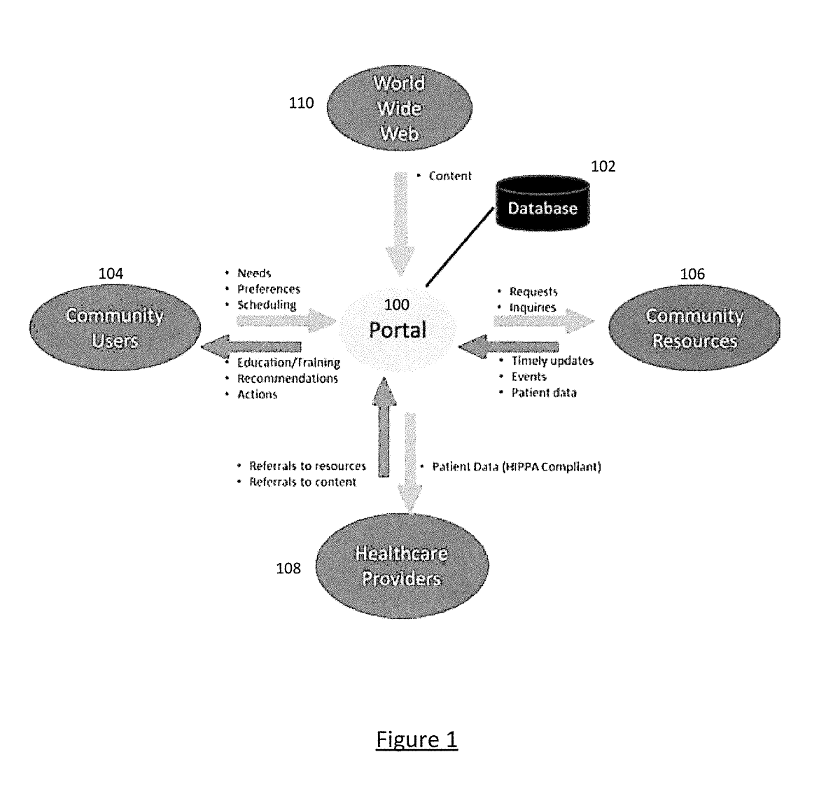

FIG. 1 illustrates an exemplary system to facilitate access to healthcare and social service resources in accordance with an example embodiment of the present invention. Embodiments of the current invention provide a Portal to facilitate a multi-sided system for connecting users (i.e., patients) with local resources (i.e., clinics, social services, products/services, education or training, etc.) and health providers (from primary care through ACUs) and for extracting valuable and relevant content from the interne.

A cloud-based portal, such as Portal 100, may facilitate connections between Community Users 104, Community Resources 106, and Healthcare Providers 108. The Portal 100 is a computer based system connecting user needs to services in a way that facilitates and promotes better health in a community by using guided processes. The Portal 100 may have access to physical storage, such as database 102, for storing information relating to community users, community resources, healthcare providers, educational materials, and such.

The Portal 100 may further provide for analysis of information regarding community users, community resources, and healthcare providers to determine how resources are being used and to develop additional resources and opportunities to positively impact the health of a community.

Embodiments may provide a social networking platform connecting Community Users 104, Community Resources 106, and Healthcare Providers 108 as part of a community engagement network. Such embodiments may trigger healthcare, social service, and educational professionals in a community to act as intermediaries to connect members of a community without access to technology to technology-based healthcare and social service resources.

The Community Users 104 are any people within a designated area, town, city, county, or state that may need resources for health or social services improvement. More naturally, the Portal 100 is beneficial for those users without the means or ability to otherwise explore what services or products are available to them. The Community Users 104 may provide indications of preferences, such as through profiles, needs, and scheduling, which the Portal 100 may use to build tailored recommendations for resources, education or training, or personal actions to assist with the individual's current needs and guide improvement in the individual's health. The Portal 100 may also provide feedback to Community Users 104 regarding their use of resources, their performance or progress toward goals, etc.

The Community Resources 106 may include any of a list of community healthcare or social services resources and also include many other secondary resources vital to facilitating individual improvement including pharmacies, health food stores, medical device stores, transportation resources, nutritionists, groups that support local health, and many more. Community Resources 106 may also include educational and training resources from multiple sources that can be accessed by Community Users.

The Community Resources 106 may provide information to the Portal 100 that may be used to better connect the resources with individuals. Such information may include, but not be limited to, specific services and/or products offered, contact information, business or work hours, languages spoken, scheduling or status of events or activities, types of insurance accepted, or any other appropriate types of information. The Community Resources 106 may also provide the Portal 100 with information related to use of services and/or anonymized or HIPPA-compliant patient information to provide analysis of community health trends or effectiveness of community promotions, as well as for use in developing additional resources or opportunities to improve community health.

The Community Resources 106 may receive and respond to requests and/or inquiries from Community Users 104 or Healthcare Providers 108 through the Portal 100. Community Resources 106 may also receive feedback through Portal 100, such as user reviews of their services or products, for example.

Healthcare Providers 108 may include many different types of providers from primary care physicians to nurses to hospitals that have responsibility and resources for delivering health and wellness services to the community. The Healthcare Providers 108 may provide referrals to Community Resources 106 or other content that may be relevant to a user through the Portal 100. The Healthcare Providers 108 may also receive information from the Portal 100, such as information about users who are patients and use of resources by patients (e.g., HIPPA-compliant patient data). For example, if a Healthcare Provider 108 suggests that a Community User 104 go to a gym, the gym (Community Resource 106) may provide status to the Healthcare Provider 108 on the frequency of use of the gym by that Community User 104.

Additionally, the Portal 100 may provide access to appropriate content, such as educational and training materials, from the third-party sources, such as the World Wide Web 110. The Portal 100 may provide the ability for Healthcare Providers 108 or Community Resources 106 to review or filter such content to meet the specific needs of an individual.

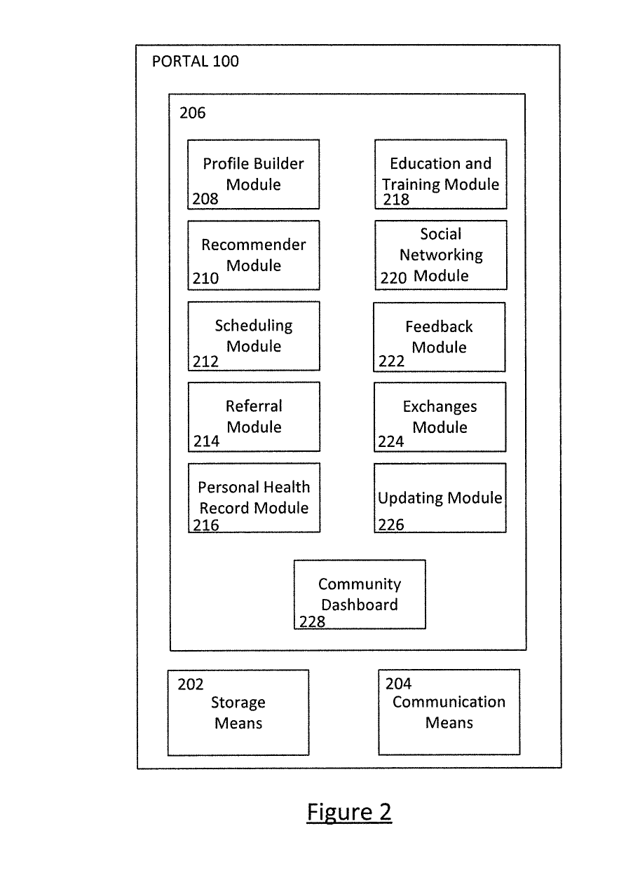

FIG. 2 is an illustration of a portal, such as Portal 100 in FIG. 1, which may provide access to healthcare and social service resource in accordance with an example embodiment of the present invention.

The Portal 100 may be comprised of one or more devices, such as network servers, etc., that provide for operations in accordance with the example embodiments. Such devices may include the physical means for storing information, transmitting and receiving information to and from various devices that communicate through networks, such as the internet, and may have software or program instructions that, when executed, provide for operations in accordance with the example embodiments.

The Portal 100 may comprise a storage means 202, either local or remote, such as database 102 of FIG. 1, that may store data related to users, resources, content, etc. The Portal 100 may further comprise communication means 204 that provide means the Portal 100 to communicate with distributed devices through a network, such as the internet or a private network.

The Portal 100 may comprise software 206 comprised of a variety of modules that perform operations in accordance with example embodiments of the current invention. Software 206 may comprise one or more of a profile builder module 208, a recommender module 210, a scheduling module 212, a referral module 214, a personal health record module 216, an education and training module 218, a social networking module 220, a feedback module 222, a exchanges module 224, an updating module 226, and a community dashboard module 228.

The profile builder module 208 may provide operations for Community Users 104, Community Resources 106, or Healthcare Providers 108, to build their presence on the Portal 100. The profile builder module 208 may, for example, allow a Community User 104 to build a personalized profile for use in selecting resource recommendations. For example, profile builder module 208 may allow for indications of a preferred language, personal preferences such as seeing a female versus a male provider, location and transportation preferences such as closest resources to their home or public transportation routes, chronic conditions suffered by the user to target resources familiar with those conditions, a preference for resources that cater to a particular age group, special needs such as if the user is handicapped or needs sight or hearing assistance, and whether the user is a parent and will need to access resources for their children.

The profile builder module 208 may also allow a Community Resource 106 or Healthcare Provider 108 to build a profile for indicating such information as services available, business hours, contact information, etc., as described above with regard to FIG. 1.

The recommender module 210 may provide operations to select recommendations based on the needs and preferences of a Community User 104 and needs and resources most used by persons similar to the Community User 104 (closest neighborhood theory). Recommendations can be any number of resources, products or services; such as identifying unique, tailored and appropriate resources, reminders to alert both Community Users 104 and Healthcare Professionals 108 of an upcoming or urgent meeting, event, or therapy, etc.

The scheduling module 212 may provide operations to facilitate scheduling an appointment with identified resources such as a healthcare professional and may also include operations for providing reminders.

The referral module 214 may provide operations to facilitate a Healthcare Provider 108 providing a recommendation for a particular Community Resource 106 or for particular educational content.

The Personal Health Record (PHR) module 216 may provide operations to facilitate a Community User 104 developing a secure HIPPA-compliant PHR to collect and store ongoing health data.

The education and training module 218 may provide operations to facilitate porting specific media from multiple sources (such as third-party educational websites, provider educational materials, etc.) to assist a Community User 104 understand, deal with, or take action on their particular health needs.

The social networking module 220 may provide operations to facilitate connections between Community Users 104 based on similarity of interest or need, such as connecting users with ‘users like me’, to share stories or information and learn from others in their community about dealing with their issues or to provide a social space to share their concerns.

The feedback module 222 may provide operations to facilitate users receiving feedback from the Portal 100. For instance, Healthcare Providers 108 may receive information from a Community Resource 106 as to the status of their patient's interaction with that resource. A Community Resource 106 may receive information from Community Users 104 or Healthcare Providers 108 regarding their services or products, such as quality reviews from users. A Community User 104 may also receive feedback from Community Resources or Healthcare Providers as to the performance or progress toward a goal or their use of resources.

The exchanges module 224 may provide operations to facilitate the exchange of information across ‘silos’, such as information in Electronic Health Records (EHR) or Personal Health Records (PHR).

The updating module 226 may provide operations to facilitate users and resources updating the information in their profiles to assure timeliness of information. For example, updating module 226 may provide reminders that events have passed or that information has become stale and direct a user to update the information.

The Community Health and Social Services Dashboard module 228 may provide operations to make information available to assist community healthcare managers to monitor the overall health of the community. For example, the data repository of Portal 100 may be made available as ‘de-identified’ (HIPPA compliant) data to allow for analysis of trends within a community and allow for assessing and monitoring any community intervention and the response. Community Health and Social Services Dashboard module 228 may provide a graphical user interface that depicts various user selected parameters for monitoring. For example, the effectiveness of an advertising campaign to increase pediatric dental care can be monitored by seeing an increase in scheduling at local dental offices.

In some embodiments, HIPAA-compliant Community User data as well as any and all other protected personal health information collected by the Portal would not be shared with any Community Resource. Additionally, HIPAA-compliant Community User data as well as any and all other protected personal health information collected by the Portal would not be shared with any Healthcare Provider except when specifically authorized by the Community User.

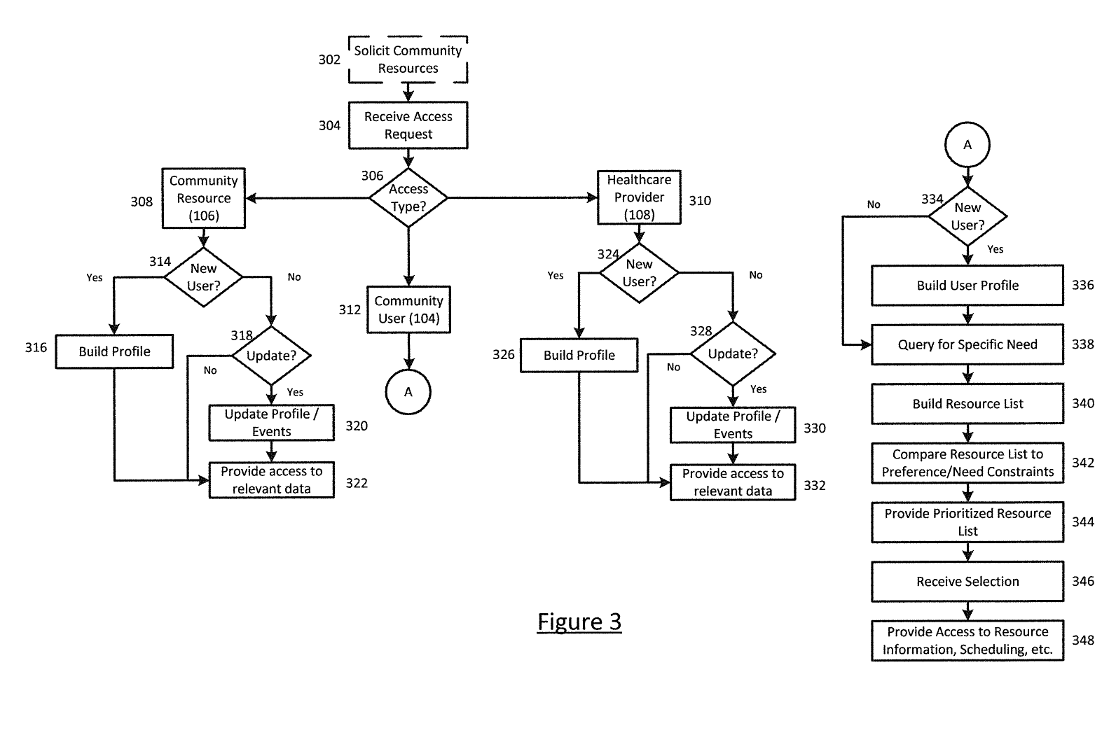

FIG. 3 is a flow chart illustrating operations performed by a system in accordance with an example embodiment of the present invention.

As shown in block 302, the Portal may be seeded with Community Resources 106 by soliciting all community resources to enter vital information that will be used to better connect that resources with individuals. Such solicitation of Community Resources 106 may be performed upon setup of the Portal or may be part of the ongoing operation to increase the robustness of the Portal resources.

As shown in block 304, the Portal may receive a request from a user to access the Portal. Upon receiving the request, the Portal may determine what type of user is requesting access, as shown in block 306. The Portal may determine whether the user is a Community Resource 106 (block 308), Community User 104 (block 312), or Healthcare Provider 108 (block 310) and direct the flow of operations as appropriate.

If the Portal determines that the user is a Community Resource user, operation may proceed to block 308. At block 314, the Portal may determine whether the Community Resource user is a new user or a previously registered user.

If the Community Resource user is a new user, operation may proceed to block 316 where the user may be registered as a Community Resource member and a Community Resource profile may be built. The profile may include information that can be used to provide connections between Community Users 104 and the Community Resource 106. Such information may include, but is not limited to, the specific services or products offered, work hours, languages spoken in the office, events or activities offered, type of insurance accepted, and date of latest update of information. Once the Community Resource profile has been completed, operation may continue to block 322 where the Portal may provide access to relevant data from the Portal, such as information on the target community population, resource needs, collaboration, etc.

If the Community Resource user is already a member of the Portal, operation may proceed to block 318 where the Community Resource user may be prompted to update the Community Resource profile or events scheduled for the Community Resource 106. If updates are received, the Portal may update the profile and/or events for the Community Resource 106 at block 320. If there are no updates, the operation may continue to block 322 where the Portal may provide access to relevant data from the Portal, such as information on the target community population, resource needs, collaboration, etc.

If the Portal determines that the user is a Healthcare Provider user, operation may proceed to block 310. At block 324, the Portal may determine whether the Healthcare Provider user is a new user or a previously registered user.

If the Healthcare Provider user is a new user, operation may proceed to block 326 where the user may be registered as a Healthcare Provider member and a Healthcare Provider profile may be built. The profile may include information that can be used to provide connections between Community Users 104 and the Healthcare Provider 108. Such information may include, but is not limited to, the specific services or products offered, work hours, languages spoken in the office, events or activities offered, type of insurance accepted, and date of latest update of information. Once the Healthcare Provider profile has been completed, operation may continue to block 332 where the Portal may provide access to relevant data from the Portal, such as information on the target community population, resource needs, collaboration, status of patients, etc.

If the Healthcare Provider user is already a member of the Portal, operation may proceed to block 328 where the Healthcare Provider user may be prompted to update the Healthcare Provider profile or events scheduled for the Healthcare Provider 108. If updates are received, the Portal may update the profile and/or events for the Healthcare Provider 108 at block 330. If there are no updates, the operation may continue to block 332 where the Portal may provide access to relevant data from the Portal, such as information on the target community population, resource needs, collaboration, status of patients, etc.

If the Portal determines that the user is a Community User 104, operation may proceed to block 312. At block 334, the Portal may determine whether the Community User 104 is a new user or a previously registered user.

If the Community User 104 is a new user, operation may proceed to block 336 where the user may be registered as a Community User member of the Portal and a Community User profile may be built. The Community User profile may collect the individual's vital information, preferences, and specific needs or conditions. Once the Community User profile has been completed, operation may continue to block 338 where the Portal may receive a specific query from the Community User 104 for a particular need. The Portal may then use the query to develop a list of available resources for the particular need at block 340. The Portal may then refine the resource list by comparing the resources to the Community User's preferences and/or constraints from the profile, as shown in block 342. At block 344, the Portal may use this comparison to provide an individualized and prioritized list of recommendations to the Community User 104 that best meet their needs and preferences. For example, if a person is looking for a nutritionist and has a chronic condition of diabetes, and the person has no means of transport, the Portal may provide a list of community nutritionists prioritized by those that both cater to diabetic patients and ones closest to the individual's home or along public transportation routes. At block 346, the Portal may receive a selection from the Community User 104 of a resource from the recommendation list. As shown in block 348, the Portal may then provide access to information about the selected resource, scheduling for the resource, etc. to facilitate the Community User's interaction with the selected resource.

If the Community User 104 is already a member of the Portal, operation may proceed to block 338 and proceed with operations as described above.

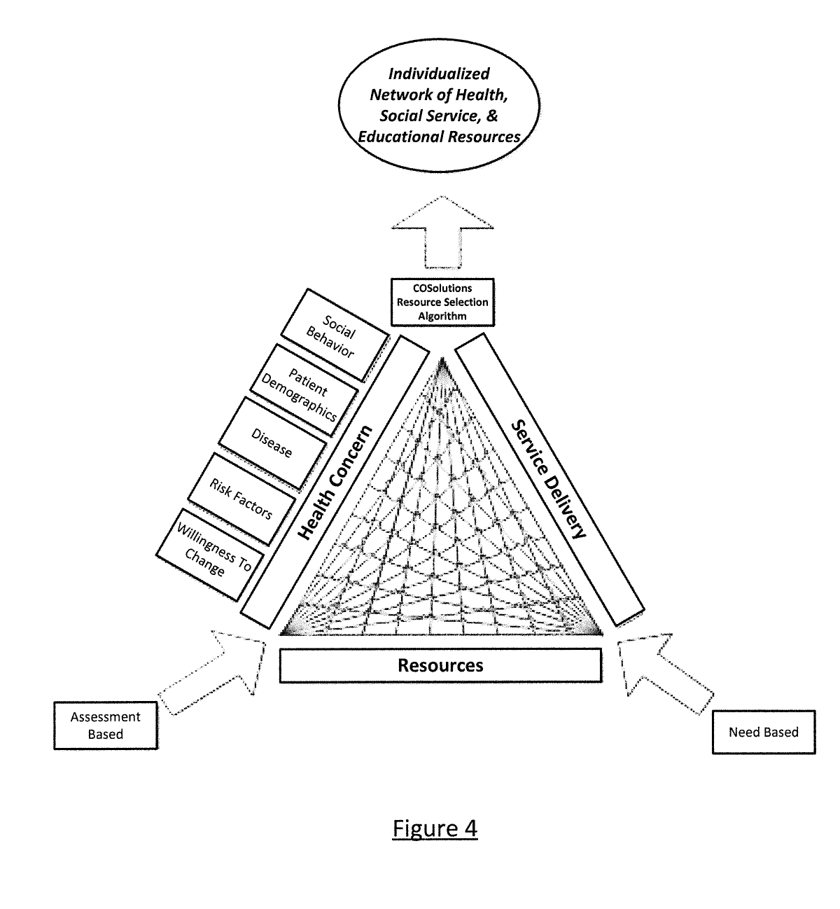

FIG. 4 illustrates aspects of the Portal from the perspective of a Community User 104 according to some example embodiments. The Portal may provide two basic points of engagement for a Community User 104 to interact with the Portal and receive recommendations or information on community resources. A Community User 104 may interact with the Portal from a “Need Based” approach where a Community User 104 is in need of recommendations or information about known community resources. A Community User 104 may use the Portal to determine one or more particular resources that meet the Community User's needs and constraints. A Community User 104 may also interact with the Portal from an “Assessment Based” approach where a Community User 104 may participate in one or more assessments to identify resources. For example, such assessments could be part of a community health assessment, personal health assessment, personal needs assessment, community resource assessment, or the like. The Portal may analyze the information provided relative to Community Resources 106, the manner in which resource services may be delivered, and the Community User's health concerns. In some embodiments, health concerns may include one or more of user willingness to change, user risk factors, user disease state/health condition, demographics, and social behaviors, for example.

In some embodiments, information provided to Community Resources 106 and/or Healthcare Providers 108 may include summary statistics, performance reports, charts, graphs, and other visual forms of information based upon de-identified health information, non-HIPAA user data, and user activity information (i.e., resources sought, resources used, visitation rates/patterns) as well as complementary information obtained from public domain data sources related to the purpose for which the Portal is deployed.

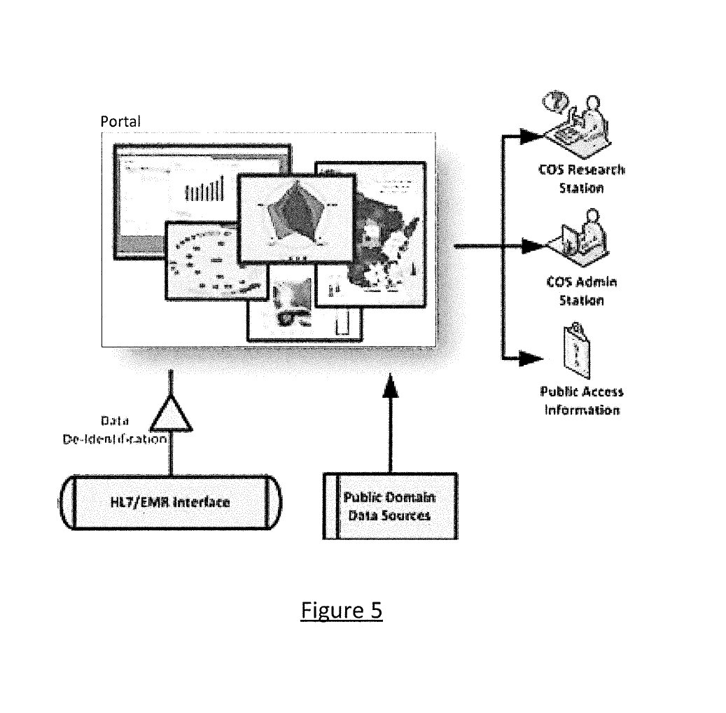

FIG. 5 illustrates an example of the collection and provision of some of the information that may be provided to Community Resources 106 and/or Healthcare Providers 108 according to some exemplary embodiments. The Portal may receive and/or collect de-identified healthcare data, data from public domain sources, or the like. The portal may provide for processing of the collected data to be output as reports, statistics, or the like, to various users of the Portal.

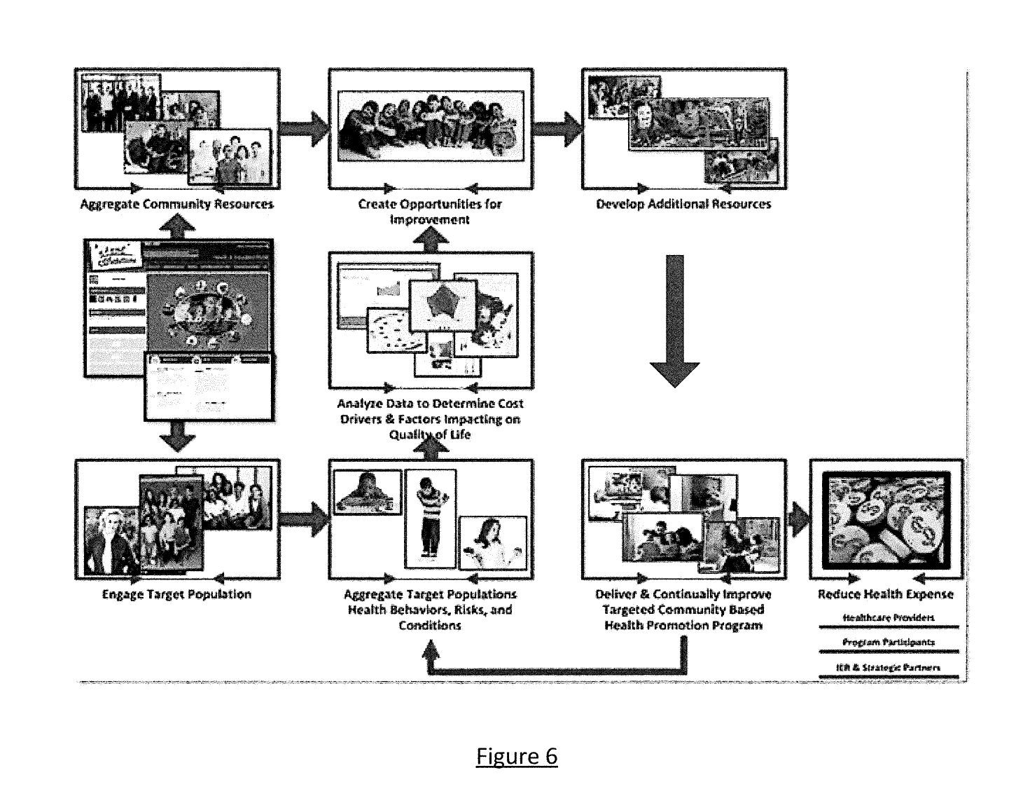

FIG. 6 is a flow chart illustrating example processes which may be provided by a system to assist in improving the health of a community in accordance with an example embodiment of the present invention.

As shown in FIG. 6, a system according to example embodiments may facilitate the aggregation of community resources as well as engage a target community population in connecting with and using the community resources to improve the use of healthcare and social services in the community. The exemplary system may further aggregate the health behaviors, risks, and conditions of the target population, including the use of community resources. The system may then provide for analysis of data to determine cost drivers and other factors having an impact on the health and quality of life for individuals in the community. The system may facilitate using such analysis to assist in determining opportunities to provide improvements in the health of a community and provide for the development of additional resources to meet the community needs. The system may further facilitate delivering and continually improving community based health programs and further engage the target population and allow for improvements in cost efficiency and outcomes in healthcare and social services in the community.

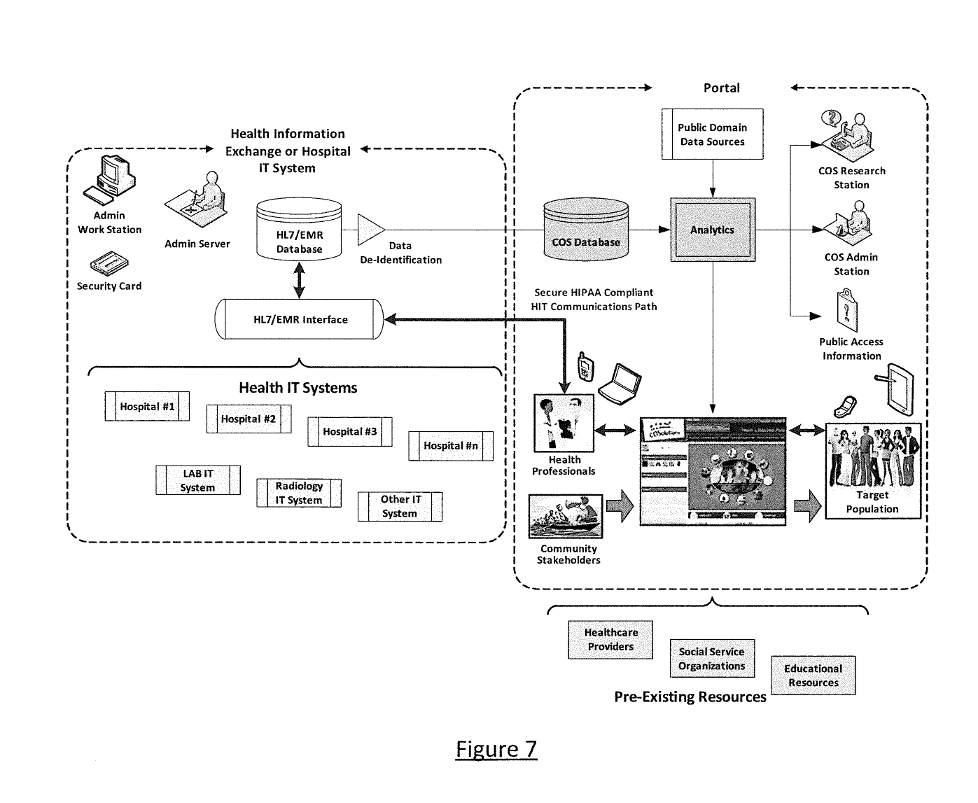

In some example embodiments, the Portal may be integrated with a Health Information Exchange or Hospital Information Technology (IT) System as illustrated in FIG. 7. As described above, the Portal may facilitate the collection of information on pre-existing community resources as well as de-identified data from a Health Information Exchange or Hospital IT System. The Portal may then facilitate recommendations and access to healthcare and social service resources in a community.

In another example embodiment, the Portal may be utilized to re-direct uninsured and under-insured Community Users to a Health Insurance Exchange where Community Users could compare plan options to select the most appropriate plan from among the plans for which they are eligible. In some embodiments, the Portal may also serve as a Health Insurance Exchange.

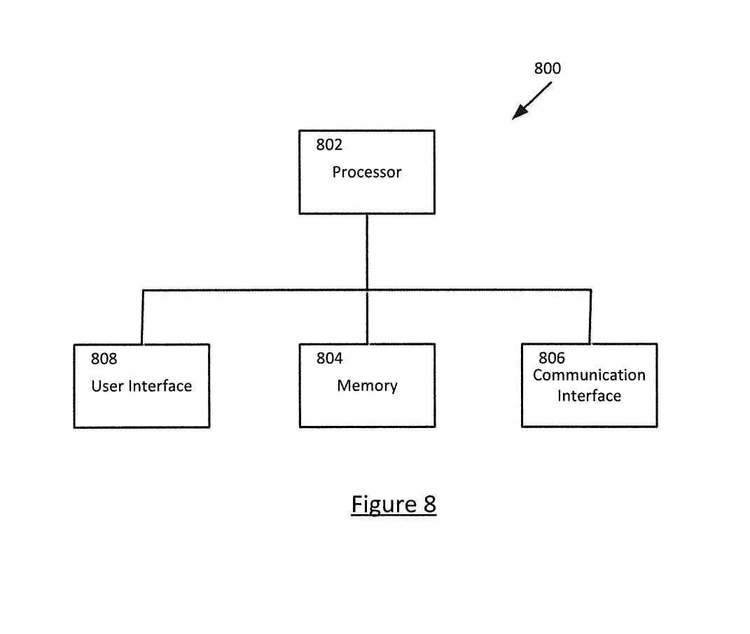

FIG. 8 is a block diagram of an apparatus that may be specifically configured in accordance with an example embodiment of the present invention.

The system of an embodiment of the present invention may include an apparatus 800 as generally described below in conjunction with FIG. 8 for performing one or more of the operations set forth by FIGS. 3 through 6 and also described above.

It should also be noted that while FIG. 8 illustrates one example of a configuration of an apparatus 800 for facilitating access to healthcare and social service resources in a community, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 8, the apparatus 800 in accordance with one example embodiment may include or otherwise be in communication with one or more of a processor 802, a memory 804, a communication interface 806, and a user interface 808.

In some embodiments, the processor (and/or co-processors or any other processing circuitry assisting or otherwise associated with the processor) may be in communication with the memory device via a bus for passing information among components of the apparatus. The memory device may include, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various operations in accordance with an example embodiment of the present invention. For example, the memory device could be configured to buffer input data for processing by the processor 802. Additionally or alternatively, the memory device could be configured to store instructions for execution by the processor.

The processor 802 may be embodied in a number of different ways. For example, the processor may be embodied as one or more of various hardware processing means such as a coprocessor, a microprocessor, a controller, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 802 may be configured to execute instructions stored in the memory device 804 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 806 may be any means such as a device or circuitry embodied in either hardware or a combination of hardware and software that is configured to receive and/or transmit data from/to a network and/or any other device or module in communication with the apparatus 800. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The apparatus 800 may include a user interface 808 that may, in turn, be in communication with the processor 802 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, microphone and/or the like. The processor and/or user interface circuitry comprising the processor may be configured to control one or more functions of one or more user interface elements through computer program instructions (e.g., software and/or firmware) stored on a memory accessible to the processor (e.g., memory 804, and/or the like).

As described above, FIG. 3 illustrates a flowchart of a method and system according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 804 of an apparatus employing an embodiment of the present invention and executed by a processor 802 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
aggregating data about a plurality of community healthcare and social service resources, wherein resource profiles are generated for each of the plurality of community resources;
generating user profiles for one or more community users, wherein the user profiles comprise indications of needs and preferences for the one or more community users in regard to healthcare and social services;
receiving a query from one of the community users regarding a need for healthcare or social services; and
generating a list of recommendations from the community resources based on the query and the user profile of the one of the community users.

2. The method according to claim 1, further comprising providing feedback regarding the community user interaction with the community resource.

3. The method according to claim 1, wherein generating the list of recommendations is further based on an analysis of similarities between a plurality of community users.

4. The method according to claim 1, wherein generating the list of recommendations is based in part on a referral from a healthcare provider.

5. The method according to claim 1, further comprising providing analysis of community user and community resource interactions wherein the analysis may be used in developing health or wellness programs for a community.

6. The method according to claim 1, further comprising providing access to content based on a need identified from the query and the community user profile.

7. The method according to claim 1, further comprising providing access to an interactive forum based on a need identified from the query and the community user profile.

8. A system comprising a plurality of devices in communication, each of the devices comprising at least one processor and at least one memory including computer program instructions, the system configured to at least:
aggregate data about a plurality of community healthcare and social service resources, wherein resource profiles are generated for each of the plurality of community resources;
generate user profiles for one or more community users, wherein the user profiles comprise indications of needs and preferences for the one or more community users in regard to healthcare and social services;
receive a query from one of the community users regarding a need for healthcare or social services; and
generate a list of recommendations from the community resources based on the query and the user profile of the one of the community users.

9. The system according to claim 8, the system further configured to provide feedback regarding the community user interaction with the community resource.

10. The system according to claim 8, wherein generating the list of recommendations is further based on an analysis of similarities between a plurality of community users.

11. The system according to claim 8, wherein generating the list of recommendations is based in part on a referral from a healthcare provider.

12. The system according to claim 8, the system further configured to provide analysis of community user and community resource interactions wherein the analysis may be used in developing health or wellness programs for a community.

13. The system according to claim 8, the system further configured to provide access to content based on a need identified from the query and the community user profile.

14. The system according to claim 8, the system further configured to provide access to an interactive forum based on a need identified from the query and the community user profile.

15. A computer program product comprising at least one non-transitory computer-readable storage medium bearing computer program instructions embodied therein for use with a computer, the computer program instructions comprising program instructions configured to, when executed by a processor:
aggregate data about a plurality of community healthcare and social service resources, wherein resource profiles are generated for each of the plurality of community resources;
generate user profiles for one or more community users, wherein the user profiles comprise indications of needs and preferences for the one or more community users in regard to healthcare and social services;
receive a query from one of the community users regarding a need for healthcare or social services; and
generate a list of recommendations from the community resources based on the query and the user profile of the one of the community users.

16. The computer program product according to claim 15 further comprising program instructions configured to provide feedback regarding the community user interaction with the community resource.

17. The computer program product according to claim 15 wherein generating the list of recommendations is further based on an analysis of similarities between a plurality of community users.

18. The computer program product according to claim 15 wherein generating the list of recommendations is based in part on a referral from a healthcare provider.

19. The computer program product according to claim 15 further comprising program instructions configured to provide analysis of community user and community resource interactions wherein the analysis may be used in developing health or wellness programs for a community.

20. The computer program product according to claim 15 further comprising program instructions configured to provide access to content or to an interactive forum based on a need identified from the query and the community user profile.
